(19) United States
(12) Patent Application Publication
(10) Pub. No.: US 2014/0270710 A1
(43) Pub. Date: Sep. 18, 2014

(54) OPTIMIZED AUDIO ENABLED CINEMAGRAPH

(71) Applicant: NOKIA CORPORATION, Espoo (FI)

(72) Inventors: Miikka Tapani Vilermo, Siuro (FI); Mikko Tapio Tamm, Tampere (FI)

(73) Assignee: NOKIA CORPORATION, Espoo (FI)

(21) Appl. No.: 13/801,164

(22) Filed: Mar. 13, 2013

(51) Int. Cl. H04N 9/79

(52) U.S. Cl. CPC H04N 9/79
USPC 386/285

(57) ABSTRACT

Methods, apparatuses, and computer program products are provided according to example embodiments in order to create optimized audio enabled cinemagraphs. In the context of a apparatus, the apparatus comprises at least one processor and at least one memory including computer program instructions, the at least one memory and the computer program instructions configured to, with the at least one processor, cause the apparatus at least to receive at least two image frames and audio, wherein the duration of the audio is longer than the duration of the at least two image frames; receive a selection of a segment of the at least two image frames; define an output image by looping the selected segment of the at least two image frames; define an output audio from the received audio based at least on a start time and a stop time of the selected segment; and produce an animated image by at least combining the output image and the output audio. A corresponding method and computer program product are also provided.

### TECHNOLOGICAL FIELD

An example embodiment of the present invention relates generally to cinemagraphs, and more particularly to providing audio enabled cinemagraphs.

### BACKGROUND

Cinemagraphs are animated photographs where a part of the image moves repeatedly. Cinemagraphs can be created by automated programs, such as the Nokia Lumia 920 Cinemagraph Lens Application, where a user starts the cinemagraph lens, records a scene for a moment and then chooses which area of the video is animated. Current cinemagraphs do not provide audio.

### BRIEF SUMMARY

Methods, apparatuses, and computer program products are provided according to example embodiments of the present invention in order to create optimized audio enabled cinemagraphs.

In one embodiment, a method is provided that at least includes receiving at least two image frames and audio, wherein the duration of the audio is longer than the duration of the at least two image frames; receiving a selection of a segment of the at least two image frames; defining an output image by looping the selected segment of the at least two image frames; defining an output audio from the received audio based at least on a start time and a stop time of the selected segment; and producing an animated image by at least combining the output image and the output audio.

In some embodiments, receiving the at least two image frames and audio may comprise causing recording of image frames and audio and/or receiving previously recorded image frames and audio. In some embodiments, receiving the of the at least two image frames and audio may comprise recording of at least one audio signal and recording of at least two image frames, wherein the recording of the at least one audio signal begins before and ends after the recording of at the least two image frames.

In some embodiments, the selection of the segment of the at least two image frames may comprise one of: automatically selecting a whole image comprising the at least two frames, receiving a selection of a whole image comprising the at least two frames, or receiving a selection of at least one region of a whole image comprising the at least two frames for generating a dynamic region and a selection of a region of the whole image for generating a substantially static region.

In some embodiments, the duration of the output audio may be an integer multiple of the duration of the output image. In some embodiments, generating the animated image may further comprise overlapping multiple instances of the output audio by a specified duration. In some embodiments, producing the animated image may further comprise the output image and the output audio being synchronized at regular intervals.

In some embodiments, the method may further comprise determining an amount of audio overlap to be used in generating the animated image; determining an amount of audio segments in the received audio before and after the output image, wherein an audio segment is the same length as the output image; determining a desired length for the output audio; and selecting an integer multiple of audio segments before and after the output image to generate the desired length output audio.

In some embodiments, the method may further comprise determining an amount of audio overlap to be used in generating the animated image; determining an amount of audio segments in the received audio before and after the output image, wherein an audio segment is the same length as the output image; determining a desired length for the output audio; generating a set of potential audio outputs, wherein the potential audio outputs are different combinations of the audio segments before and after the output image which provide the desired length output audio; for each potential audio output, determining at least one of: a correlation between an overlap segment at the beginning of the potential audio output and an overlap segment at the end to of the potential audio output and a quietness of an overlap segment at the beginning of the potential audio output and an overlap segment at the end to of the potential audio output, wherein the overlap segments are equal to the amount of audio overlap; and selecting the potential audio output with the best correlation or that produces the quietest overlap as the output audio for use in generating the animated image.

In some embodiments, the method may further comprise determining an amount of audio overlap to be used in generating the animated image; determining an amount of audio segments in the received audio before and after the output image, wherein an audio segment is the same length as the output video loop; causing display of a received image frame timeline and a received audio timeline; causing display of an indication of the output image on the timelines; receiving a selection of a start position and a stop position on the received audio timeline; and generating the output audio using a segment of received audio between the start position and the stop position.

In another embodiment, an apparatus is provided that includes at least one processor and at least one memory including computer program instructions with the at least one memory and the computer program instructions configured to, with the at least one processor, cause the apparatus at least to receive at least two image frames and audio, wherein the duration of the audio is longer than the duration of the at least two image frames; receive a selection of a segment of the at least two image frames; define an output image by looping the selected segment of the at least two image frames; define an output audio from the received audio based at least on a start time and a stop time of the selected segment; and produce an animated image by at least combining the output image and the output audio.

In some embodiments, the at least one memory and the computer program instructions may be further configured to, with the at least one processor, cause the apparatus to record image frames and audio or receive previously recorded image frames and audio. In some embodiments, the at least one memory and the computer program instructions may be further configured to, with the at least one processor, cause the apparatus to record at least one audio signal and record image frames, wherein the recording of the at least one audio signal begins before and ends after the recording of image frames.

In some embodiments, the selection of the segment of the at least two image frames comprises one of automatically selecting a whole image comprising the at least two image frames, receiving a selection of a whole image comprising the at least two image frames, or receiving a selection of at least one region of a whole image comprising the at least two image frames for generating a dynamic region and a selection of a region of the whole image for generating a substantially static region.

In some embodiments, the duration of the output audio may be an integer multiple of the duration of the output image. In some embodiments, producing the animated image may further comprise overlapping multiple instances of the output audio by a specified duration.

In some embodiments, the at least one memory and the computer program instructions may be further configured to, with the at least one processor, cause the apparatus at least to determine an amount of audio overlap to be used in generating the animated image; determine an amount of audio segments in the received audio before and after the output image, wherein an audio segment is the same length as the output image; determine a desired length for the output audio; and select an integer multiple of audio segments before and after the output image to generate the desired length output audio.

In some embodiments, the at least one memory and the computer program instructions may be further configured to, with the at least one processor, cause the apparatus at least to determine an amount of audio overlap to be used in generating the animated image; determine an amount of audio segments in the received audio before and after the output image, wherein an audio segment is the same length as the output image; determine a desired length for the output audio; generate a set of potential audio outputs, wherein the potential audio outputs are different combinations of the audio segments before and after the output image which provide the desired length output audio; for each potential audio outputs, determine at least one of: a correlation between an overlap segment at the beginning of the potential audio output and an overlap segment at the end to of the potential audio output and a quietness of an overlap segment at the beginning of the potential audio output and an overlap segment at the end to of the potential audio output, wherein the overlap segments are equal to the amount of audio overlap; and select the potential audio output with the best correlation or that produces the quietest overlap as the output audio for use in generating the animated image.

In some embodiments, the at least one memory and the computer program instructions may be further configured to, with the at least one processor, cause the apparatus at least to determine an amount of audio overlap to be used in generating the animated image; determine an amount of audio segments in the received audio before and after the output image, wherein an audio segment is the same length as the output image; cause display of a received image frames timeline and a received audio timeline; cause display of an indication of the output image on the timelines; receive a selection of a start position and a stop position on the received audio timeline; and generate the output audio using the segment of received audio between the start position and the stop position.

In some embodiments, the apparatus may further comprise a user interface, the user interface configured to provide for display of the recorded video; provide for selection of the recorded video segment and selection of the video regions for generating a dynamic region and a substantially static region; provide for display of a recorded video timeline and a recorded audio timeline; and provide for selection of a start position and a stop position on the audio timeline.

In a further embodiment, a computer program product is provided that includes at least one non-transitory computer-readable storage medium bearing computer program instructions embodied therein for use with a computer with the computer program instructions including program instructions configured to receive at least two image frames and audio, wherein the duration of the audio is longer than the duration of the at least two image frames; receive a selection of a segment of the at least two image frames; define an output image by looping the selected segment of the at least two image frames; define an output audio from the received audio based at least on a start time and a stop time of the selected segment; and produce an animated image by at least combining the output image and the output audio.

In some embodiments, the program instructions may be further configured to record image frames and audio or receive previously recorded image frames and audio. In some embodiments, the program instructions may be further configured to record at least one audio signal and record at least two image frames, wherein the recording of the at least one audio signal begins before and ends after the recording of image frames.

In some embodiments, the selection of the segment of the at least two image frames may comprise one of automatically selecting a whole image comprising the at least two image frames, receiving a selection of a whole image comprising the at least two image frames, or receiving a selection of at least one region of a whole image comprising the at least two image frames for generating a dynamic region and a selection of a region of the whole image for generating a substantially static region.

In some embodiments, the program instructions may be further configured to determine an amount of audio overlap to be used in generating the animated image; determine an amount of audio segments in the received audio before and after the output image, wherein an audio segment is the same length as the output image; determine a desired length for the output audio; and select an integer multiple of audio segments before and after the output image to generate the desired length output audio.

In some embodiments, the program instructions may be further configured to determine an amount of audio overlap to be used in generating the animated image; determine an amount of audio segments in the received audio before and after the output image, wherein an audio segment is the same length as the output image; determine a desired length for the output audio; generate a set of potential audio outputs, wherein the potential audio outputs are different combinations of the audio segments before and after the output image which provide the desired length output audio; for each potential audio outputs, determine at least one of: a correlation between an overlap segment at the beginning of the potential audio output and an overlap segment at the end to of the potential audio output and a quietness of an overlap segment at the beginning of the potential audio output and an overlap segment at the end to of the potential audio output, wherein the overlap segments are equal to the amount of audio overlap; and select the potential audio output with the best correlation or that produces a quietest overlap as the output audio for use in generating the animated image.

In some embodiments, the program instructions may be further configured to determine an amount of audio overlap to be used in generating the animated image; determine an amount of audio segments in the received audio before and after the output image, wherein an audio segment is the same length as the output image; cause display of a received image frames timeline and a received audio timeline; cause display of an indication of the output image on the timelines; receive a selection of a start position and a stop position on the received audio timeline; and generate the output audio using the segment of received audio between the start position and the stop position.

In another embodiment, an apparatus is provided that includes at least means for receiving at least two image frames and audio, wherein the duration of the audio is longer than the duration of the at least two image frames; means for receiving a selection of a segment of the at least two image frames; means for defining an output image by looping the selected segment of the at least two image frames; means for defining an output audio from the received audio based at least on a start time and a stop time of the selected segment; and means for producing an animated image by at least combining the output image and the output audio.

In some embodiments, the means for receiving the at least two image frames and audio may comprise means for causing recording of image frames and audio or means for receiving previously recorded image frames and audio. In some embodiments, the means for receiving the of the at least two image frames and audio may comprise means for recording of at least one audio signal and means for recording of at least two image frames, wherein the recording of the at least one audio signal begins before and ends after the recording of at the least two image frames.

In some embodiments, the means for generating the output audio may further comprise means for determining an amount of audio overlap to be used in generating the animated image; means for determining an amount of audio segments in the received audio before and after the output image, wherein an audio segment is the same length as the output image; means for determining a desired length for the output audio; and means for selecting an integer multiple of audio segments before and after the output image to generate the desired length output audio.

In some embodiments, the means for generating the output audio may further comprise means for determining an amount of audio overlap to be used in generating the animated image; means for determining an amount of audio segments in the received audio before and after the output image, wherein an audio segment is the same length as the output image; means for determining a desired length for the output audio; means for generating a set of potential audio outputs, wherein the potential audio outputs are different combinations of the audio segments before and after the output image which provide the desired length output audio; means for determining at least one of: a correlation between an overlap segment at the beginning of the potential audio output and an overlap segment at the end to of the potential audio output and a quietness of an overlap segment at the beginning of the potential audio output and an overlap segment at the end to of the potential audio output, wherein the overlap segments are equal to the amount of audio overlap; and means for selecting the potential audio output with the best correlation or that produces a quietest overlap as the output audio for use in generating the animated image.

In some embodiments, the means for generating the output audio may further comprise means for determining an amount of audio overlap to be used in generating the animated image; means for determining an amount of audio segments in the received audio before and after the output image, wherein an audio segment is the same length as the output video loop; means for causing display of a received image frame timeline and a received audio timeline; means for causing display of an indication of the output image on the timelines; means for receiving a selection of a start position and a stop position on the received audio timeline; and means for generating the output audio using a segment of received audio between the start position and the stop position.

### BRIEF DESCRIPTION OF THE DRAWINGS

Having thus described certain embodiments of the invention in general terms, reference will now be made to the accompanying drawings, which are not necessarily drawn to scale, and wherein:

FIG. 1 is a block diagram of an apparatus that may be specifically configured in accordance with an example embodiment of the present invention;

FIG. 2 is a flow chart illustrating operations such as performed by an apparatus of FIG. 1 that is specifically configured in accordance with an example embodiment of the present invention;

FIG. 3 illustrates an exemplary video clip and audio clip which may be used in generating an audio enabled cinemagraph in accordance with example embodiments of the present invention;

FIG. 4 illustrates a flowchart of operations for generating an audio loop segment in accordance with an example embodiment of the present invention;

FIG. 5 illustrates an exemplary audio enabled cinemagraph which may be generated in accordance with example embodiments of the present invention;

FIG. 6 illustrates a flowchart of operations for generating an audio loop segment in accordance with an example embodiment of the present invention;

FIG. 7 illustrates a flowchart of operations for generating an audio loop segment in accordance with an example embodiment of the present invention;

FIG. 8 illustrates a flowchart of operations for generating an audio loop segment in accordance with an example embodiment of the present invention;

FIG. 9 illustrates a flowchart of operations for generating an audio loop segment in accordance with an example embodiment of the present invention; and

FIG. 10 illustrates an exemplary apparatus and user interface for generating an audio loop in accordance with an example embodiment of the present invention.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a non-transitory physical storage medium (e.g., volatile or non-volatile memory device), can be differentiated from a “computer-readable transmission medium,” which refers to an electromagnetic signal.

Methods, apparatuses and computer program products are provided in accordance with example embodiments of the present invention to create optimized audio enabled cinemagraphs or animated images.

In some example embodiments, video and audio may be captured simultaneously for use in generating an audio enabled cinemagraph. In some embodiments, audio may be recorded for a period longer than the duration of the portion of the recorded video that may be used for looping when a cinemagraph is created. An audio length may be selected in integer multiples of the video loop length before and after the video loop segment to create the audio loop. The audio loop may be played together with the video loop and because of the integer multiples used for the audio loop, the audio may be in sync with the video at regular intervals.

In example embodiments, a device may start to record audio as soon as the cinemagraph lens application is started and ends the recording of audio only just before the audio is needed for generation of the cinemagraph. Once the video for the cinemagraph is created, information is known about where the looping segment of the video was taken from the recorded video (i.e. the start and end times of the looping video segment). This information may then be used in generating the audio for the cinemagraph.

In some example embodiments, the video and audio may be received from another device or they may be extracted from pre-recorded video and audio data. In some embodiments, the received video may comprise two or more image frames.

In some example embodiments, the video may comprise animated images comprising at least two frames, and the cinemagraph may be created from a whole image comprising the at least two frames which may either be selected automatically or may be manually selected by a user or may be created from a user selection of a region selected from the whole image comprising the at least two frames. In some embodiments, the video may comprise a series of images comprising at least two image frames.

The system of an embodiment of the present invention may include an apparatus 100 as generally described below in conjunction with FIG. 1 for performing one or more of the operations set forth by FIGS. 2, 4, and 6 through 9 and also described below. In this regard, the apparatus may be embodied by a computing device such as a personal computer, a server, a mobile device, or the like.

It should also be noted that while FIG. 1 illustrates one example of a configuration of an apparatus 100 for creating audio enabled cinemagraphs, numerous other configurations may also be used to implement other embodiments of the present invention. As such, in some embodiments, although devices or elements are shown as being in communication with each other, hereinafter such devices or elements should be considered to be capable of being embodied within the same device or element and thus, devices or elements shown in communication should be understood to alternatively be portions of the same device or element.

Referring now to FIG. 1, an apparatus 100 for creating audio enabled cinemagraphs in accordance with an example embodiment may include or otherwise be in communication with one or more of a processor 102, a memory 104, a user interface 106, a recording interface 108, and a communication interface 110.

In some embodiments, the processor (and/or co-processors or any other processing circuitry assisting or otherwise associated with the processor) may be in communication with the memory 104 via a bus for passing information among components of the apparatus. The memory device 104 may include, for example, a non-transitory memory, such as one or more volatile and/or non-volatile memories. In other words, for example, the memory 104 may be an electronic storage device (e.g., a computer readable storage medium) comprising gates configured to store data (e.g., bits) that may be retrievable by a machine (e.g., a computing device like the processor). The memory 104 may be configured to store information, data, content, applications, instructions, or the like for enabling the apparatus to carry out various functions in accordance with an example embodiment of the present invention. For example, the memory 104 could be configured to buffer input data for processing by the processor 102. Additionally or alternatively, the memory 104 could be configured to store instructions for execution by the processor.

In some embodiments, the apparatus 100 may be embodied as a chip or chip set. In other words, the apparatus may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present invention on a single chip or as a single “system on a chip.” As such, in some cases, a chip or chipset may constitute means for performing one or more operations for providing the functionalities described herein.

The processor 102 may be embodied in a number of different ways. For example, the processor may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor may include one or more processors configured in tandem via the bus to enable independent execution of instructions, pipelining and/or multithreading.

In an example embodiment, the processor 102 may be configured to execute instructions stored in the memory 104 or otherwise accessible to the processor. Alternatively or additionally, the processor may be configured to execute hard coded functionality. As such, whether configured by hardware or software methods, or by a combination thereof, the processor may represent an entity (e.g., physically embodied in circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device configured to employ an embodiment of the present invention by further configuration of the processor by instructions for performing the algorithms and/or operations described herein. The processor may include, among other things, a clock, an arithmetic logic unit (ALU) and logic gates configured to support operation of the processor.

The apparatus 100 may include a user interface 106 that may, in turn, be in communication with the processor 102 to provide output to the user and, in some embodiments, to receive an indication of a user input. For example, the user interface may include a display and, in some embodiments, may also include a keyboard, a mouse, a joystick, a touch screen, touch areas, soft keys, a microphone, a speaker, or other input/output mechanisms. The processor may comprise user interface circuitry configured to control at least some functions of one or more user interface elements such as a display and, in some embodiments, a speaker, ringer, microphone and/or the like. The processor and/or user interface circuitry comprising the processor may be configured to control one or more functions of one or more user interface elements through computer program instructions (e.g., software and/or firmware) stored on a memory accessible to the processor (e.g., memory 104, and/or the like).

The apparatus 100 may include a recording interface 108 that may, in turn, be in communication with the processor 102 to provide for capturing video or audio in some embodiments. For example, the recording interface may include a camera, one or more microphones, a video module, an audio module, and/or other recording mechanisms. For example, in an example embodiment in which the recording interface comprises a camera, the camera may include a digital camera capable of forming a digital image file from a captured image. As such, the camera may include all hardware (for example, a lens or other optical component(s), image sensor, image signal processor, and/or the like) and software necessary for creating a digital image file from a captured image and/or video. Alternatively, the camera may include only the hardware needed to view an image, while a memory device 104 of the apparatus stores instructions for execution by the processor in the form of software necessary to create a digital image file from a captured image. In an example embodiment, the camera may further include a processing element such as a co-processor which assists the processor in processing image data and an encoder and/or decoder for compressing and/or decompressing image data. The encoder and/or decoder may encode and/or decode according to, for example, a joint photographic experts group (JPEG) standard, a moving picture experts group (MPEG) standard, or other format.

The apparatus 100 may optionally include a communication interface 110 which may be any means such as a device or circuitry embodied in either hardware or a combination of hardware and software that is configured to receive and/or transmit data from/to a network and/or any other device or module in communication with the apparatus 100. In this regard, the communication interface may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may alternatively or also support wired communication. As such, for example, the communication interface may include a communication modem and/or other hardware/software for supporting communication via cable, digital subscriber line (DSL), universal serial bus (USB) or other mechanisms.

FIG. 2 is a flow chart illustrating operations for creating an audio enabled cinemagraph such as performed by an apparatus of FIG. 1 that is specifically configured in accordance with an example embodiment of the present invention.

In this regard, the apparatus 100 may include means, such as the processor 102, memory 104, or the like, for starting a cinemagraph application. See block 202 of FIG. 2. For example, the apparatus 100 may include means, such as the processor 102, memory 104, user interface 106, or the like, for receiving an indication from a user to launch the cinemagraph application.

The apparatus 100 may include means, such as the processor 102, memory 104, recording interface 108, or the like, for causing audio recording to be started. See block 204 of FIG. 2. The apparatus 100 may also include means, such as the processor 102, memory 104, recording interface 108, or the like for causing recording and storing of the audio data.

As shown in block 206 of FIG. 2, the apparatus 100 may also include means, such as the processor 102, memory 104, user interface 106, recording interface 108, or the like, for receiving an input to begin video recording. The apparatus 100 may also include means, such as the processor 102, memory 104, recording interface 108, or the like for causing recording and storing of the video data. As shown in block 208 of FIG. 2, the apparatus 100 may also include means, such as the processor 102, memory 104, user interface 106, recording interface 108, or the like, for receiving an input to stop video recording.

In alternative embodiments, the recorded video and audio may be received from another device or may be extracted from previously recorded video and audio files. In some embodiments, the received or recorded video may comprise two or more image frames.

As shown in block 210 of FIG. 2, the apparatus 100 may also include means, such as the processor 102, memory 104, user interface 106, recording interface 108, or the like, for displaying a still frame of the recorded video, such as to a user. As shown in block 212 of FIG. 2, the apparatus 100 may also include means, such as the processor 102, memory 104, user interface 106, recording interface 108, or the like, for receiving a selection of a frame area to be animated for the cinemagraph, such as from a user. In some embodiments, the frame area to be animated may comprise the whole image or the frame area to be animated may be a region of the whole image selected by a user.

As shown in block 214 of FIG. 2, the apparatus 100 may also include means, such as the processor 102, memory 104, or the like, for generating a video loop segment from the recorded video clip. Once the video loop for the cinemagraph is created, information is known about where the video looping segment was taken from the recorded video clip. As shown in block 216 of FIG. 2, the apparatus 100 may also include means, such as the processor 102, memory 104, or the like, for providing an indication of the start time and the end time of the video loop segment within the recorded video clip.

As shown in block 218 of FIG. 2, the apparatus 100 may also include means, such as the processor 102, memory 104, or the like, for generating an audio loop segment from the cinemagraph in accordance with example embodiments which are further described in regard to FIGS. 2, 4, and 6 through 9 below.

As shown in block 220 of FIG. 2, the apparatus 100 may also include means, such as the processor 102, memory 104, or the like, for combining the video loop and audio loop into an audio enabled cinemagraph, as illustrated in FIG. 5.

FIG. 3 illustrates an exemplary video clip and audio clip which may be used in generating an audio enabled cinemagraph in accordance with example embodiments of the present invention, such as by operations described in FIGS. 2, 4, and 6 through 9.

In some example embodiments, various parameters of the recorded video and audio may be used in generating the video loop and audio loop for an audio enabled cinemagraph. Such parameter values may include:
v_{b}=time when video recording was started,
vₑ=time when video recording was stopped,
c_{b}=time when video recording was at the same point where the cinemagraph video loop begins,
cₑ=time when video recording was at the same point where the cinemagraph video loop ends,
a_{b}=time when audio recording was started, and
aₑ=time when audio recording was stopped,
   which are further illustrated in FIG. 3. Because audio recording was started before video recording and because the video loop is a segment taken from the recorded video, it follows that the following equation must be true: a_{b}≦v_{b}≦c_{b}≦cₑ≦vₑ≦aₑ.

Based on the above values, the length of the looped video may be described as cₑ−c_{b}. A further parameter o may be defined as the length of audio overlap needed for smooth audio looping. In some embodiments, the overlap length may be defined to be about 0.25 seconds, for example. It is assumed that o<cₑ−c_{b} (the duration of the looping video clip). In some embodiments, there may be no audio overlap used so that o=0. Additionally, it may be assumed that cₑ+o≦aₑ because the audio was recorded for a short duration longer than the video.

FIG. 3 illustrates the recorded video 302, starting at time v_{b} and ending at time vₑ, and the recorded audio 304 starting at time a_{b} and ending at time aₑ, that were captured, such as by the recording interface 108 of apparatus 100, for use in generating an audio enabled cinemagraph. Video clip 312 is the segment of the recorded video that is to be used in generating the cinemagraph and starts at time c_{b} and ends at time cₑ. The audio clip 314 is an exemplary audio clip that may be used in generating the audio enabled cinemagraph and may be comprised of an integer multiple of length cₑ−c_{b} (i.e. the length of the looping video clip) both before and after the video clip 312. Overlap 316 is the amount of audio overlap needed for smooth audio looping.

FIG. 4 illustrates a flowchart of operations, which may be performed by an apparatus, such as apparatus 100, for generating an audio loop segment in accordance with an example embodiment as part of the operations described above with regard to FIG. 2. The operations illustrated by the flowchart of FIG. 4 may occur within block 218 of FIG. 2. Operations may begin by transitioning from block 218 of FIG. 2.

As shown in block 402 of FIG. 4, the apparatus 100 may include means, such as the processor 102, memory 104, or the like, for determining the length of the audio overlap, o, needed for smooth audio looping. For example, the overlap may be a predefined value such as 0.25 seconds in some embodiments.

The apparatus 100 may include means, such as the processor 102, memory 104, or the like, for determining the amount of audio that is available before and after the looped video clip. See block 404 of FIG. 4. In an example embodiment, the apparatus may determine the number of segments of audio equal to the length of the video loop (cₑ−c_{b}) that are available before and after the video loop. For example, the apparatus may determine the maximum number of segments M, before the video loop, and N, after audio loop, (both are non-negative integers) so that:

cₑ+N(cₑ−c_{b})+o≦aₑ and a_{b}≦c_{b}−M(cₑ≦c_{b}).

As shown in block 406 of FIG. 4, the apparatus 100 may include means, such as the processor 102, memory 104, or the like, for selecting a number of the determined audio segments before and after the video loop to use in creating the audio loop.

In some embodiments, it may be desirable that the length of audio that is looped is an integer multiple (AL) times longer that the video that is looped. In an example embodiment, AL may be defined as 7, so the audio loop length would be 7 times longer than the video loop length, for example. In example embodiments, the value of AL may depend on the length of the video loop. For example, in some embodiments a comfortable audio length may be greater than five seconds.

In an example embodiment, the audio that is selected for the audio loop may be M_{b}=3 video loop lengths before the video loop and Nₑ=3 video loop lengths after the video loop so that M_{b}+Nₑ+1=AL. However, there might not always be a sufficient number of audio segments available, that is it may be that M<M_{b} or N<Nₑ. In example embodiments, the following pseudo-code may be used to select the audio for the audio loop:

If M < M_{b} or N < Nₑ and M+N < AL

then:

audio for audio loop begins at c_{b} − M(cₑ − c_{b}) and ends at cₑ
+ N(cₑ − c_{b}) + o

elseif M < M_{b} or N < Nₑ and M+N ≧ AL

then:

M=min(M,AL−N−1)
N=min(N,AL−M−1)
audio for audio loop begins at c_{b} − M(cₑ − c_{b}) and ends at cₑ
+ N(cₑ − c_{b}) + o

else:

M = M_{b}
N = Nₑ
audio for audio loop begins at c_{b} − M(cₑ − c_{b}) and ends at cₑ
+ N(cₑ − c_{b}) + o

endif

As shown in block 408 of FIG. 4, the apparatus 100 may include means, such as the processor 102, memory 104, or the like, for aligning the repeating audio loops for playback in the audio enabled cinemagraph. For example, in some embodiments, the repeating audio loops may be aligned such that the last o seconds (audio overlap length) of the audio overlaps with the first o seconds of the audio in the next repeat of the audio loop. In some embodiments, the last o seconds of the audio loop may be faded out and the first o seconds of the audio loop may be faded in, such as by using linear of other types of fade ins and fade outs.

Operation may then return to block 220 of FIG. 2 where the audio loop and video loop may be combined to generate an audio enabled cinemagraph, as illustrated in FIG. 5.

FIG. 5 illustrates an exemplary audio enabled cinemagraph which may be generated in accordance with example embodiments of the present invention, such as by operations described in regard to FIGS. 2, 4, 6 through 9.

As shown in FIG. 5, the playback of the audio enabled cinemagraph may provide a repeating video loop 502 and a repeating audio loop 504 where the audio may be in sync with the video at regular intervals. Audio loop overlap 406 illustrates the overlap of the last o seconds of playback of an audio loop with the first o seconds of playback of the next audio loop.

In another embodiment, instead of trying to center the looped audio around the looped video, if there is enough audio available, all possible combinations of M and N could be generated and the audio from the beginning (AB) and the audio from the end (AE) of the looped audio of each combination is compared. The combination of M and N that produces the best correlation between AB and AE may then be used for creating the audio loop for the audio enabled cinemagraph. For example, if AB and AE are N samples long, such that AB=xᵢ, with i=1, . . . , N and AE=yᵢ, with i=1, . . . , N, then the correlation between AB and AE would be:

$$\frac{{\sum }_{i = 1}^{N} {x}_{i} {y}_{i}}{\sqrt[2]{{\sum }_{i = 1}^{N} {x}_{i}^{2} {\sum }_{i = 1}^{N} {y}_{i}^{2}}}$$

FIG. 6 illustrates a flowchart of operations, which may be performed by an apparatus, such as apparatus 100, for generating an audio loop segment in accordance with an example embodiment as part of the operations described above with regard to FIG. 2. The operations illustrated by the flowchart of FIG. 6 may occur within block 218 of FIG. 2. Operations may begin by continuing from block 218 of FIG. 2.

As shown in block 602 of FIG. 6, the apparatus 100 may include means, such as the processor 102, memory 104, or the like, for determining the length of the audio overlap, o, needed for smooth audio looping. For example, the overlap may be a predefined value such as 0.25 seconds in some embodiments.

The apparatus 100 may include means, such as the processor 102, memory 104, or the like, for determining the amount of audio that is available before and after the looped video clip. See block 604 of FIG. 6. In an example embodiment, the apparatus may determine the number of segments of audio equal to the length of the video loop (cₑ−c_{b}) that are available before and after the video loop. For example, the apparatus may determine the maximum number of segments M, before the video loop, and N, after audio loop, (both are non-negative integers) so that:

cₑ+N(cₑ−c_{b})+o≦aₑ, and a_{b}≦c_{b}−M(cₑ−c_{b}).

As shown in block 606 of FIG. 6, the apparatus 100 may include means, such as the processor 102, memory 104, or the like, for generating all possible combinations of M and N that generate the desired length audio loop, AL. For example, in an embodiment where AL=7, if enough audio is available, all possible combinations of M and N could be generated, for example, [M=6, N=0], [M=5, N=1], [M=4, N=2] . . . , [M=0, N=6].

As shown in block 608 of FIG. 6, the apparatus 100 may include means, such as the processor 102, memory 104, or the like, for determining the correlation between the audio from the beginning (AB) and the audio from the end (AE) of the looped audio of each combination. For example, the audio from the beginning and end of the looped audio for each combination is compared. The audio at the beginning, called AB, may be defined as the time period:

from: c_{b}−M(cₑ−c_{b}) to: c_{b}−M(cₑ−c_{b})+o,

and the audio at the end, called AE, may be defined as the time period:

from: N(cₑ−c_{b}) to: N(cₑ−c_{b})+o.

The apparatus may then determine the correlation between the AB and the AE for each combination of M and N.

As shown in block 610 of FIG. 6, the apparatus 100 may include means, such as the processor 102, memory 104, or the like, for selecting the combination of M and N that produces the best correlation between AB and AE to use in creating the audio loop for the audio enhanced cinemagraph.

As shown in block 612 of FIG. 6, the apparatus 100 may include means, such as the processor 102, memory 104, or the like, for aligning the repeating audio loops for playback in the audio enabled cinemagraph. For example, in some embodiments, the repeating audio loops may be aligned such that the last o seconds (audio overlap length) of the audio overlaps with the first o seconds of the audio in the next repeat of the audio loop. In some embodiments, the last o seconds of the audio loop may be faded out and the first o seconds of the audio loop may be faded in, such as by using linear of other types of fade ins and fade outs.

Operation may then return to block 220 of FIG. 2 where the audio loop and video loop may be combined to generate an audio enabled cinemagraph, as illustrated in FIG. 5.

In another embodiment, instead of limiting the correlation search to the few points as discussed above, the correlation could be searched more accurately. In an example embodiment, if there is enough audio available, all possible combinations of M, N and τ could be tried, were τ is an optimization variable defined as

$$τ ∈ \{ \frac{{c}_{e} - {c}_{b}}{L} l , l = 0 , … , L - 1 \} ,$$

where L defines the number of different values of τ to be tested. The audio from the beginning (AB) and the audio from the end (AE) of the looped audio of each combination is compared. The combination of M, N and τ that produces the best correlation between AB and AE may then be used for creating the audio loop for the audio enabled cinemagraph.

In an example embodiment, when the audio enabled cinemagraph is played back, the audio playback is still started from a point that is an integer multiple of the video loop length away from the video loop, e.g. from the point c_{b}−M(cₑ−c_{b}), to preserve the time synchronization between the video and the audio and also maintain the best possible correlation during the audio fade-in and fade-out.

FIG. 7 illustrates a flowchart of operations, which may be performed by an apparatus, such as apparatus 100, for generating an audio loop segment in accordance with an example embodiment as part of the operations described above with regard to FIG. 2. The operations illustrated by the flowchart of FIG. 7 may occur within block 218 of FIG. 2. Operations may begin by continuing from block 218 of FIG. 2.

As shown in block 702 of FIG. 7, the apparatus 100 may include means, such as the processor 102, memory 104, or the like, for determining the length of the audio overlap, o, needed for smooth audio looping. For example, the overlap may be a predefined value such as 0.25 seconds in some embodiments.

The apparatus 100 may include means, such as the processor 102, memory 104, or the like, for determining the amount of audio that is available before and after the looped video clip. See block 704 of FIG. 7. In an example embodiment, the apparatus may determine the number of segments of audio equal to the length of the video loop (cₑ−c_{b}) that are available before and after the video loop. For example, the apparatus may determine the maximum number of segments M, before the video loop, and N, after audio loop, (both are non-negative integers) so that:

cₑ+N(cₑ−c_{b})+o≦aₑ and a_{b}≦c_{b}−M(cₑ−c_{b}).

As shown in block 706 of FIG. 7, the apparatus 100 may include means, such as the processor 102, memory 104, or the like, for generating all possible combinations of M, N, and τ that generate the desired length audio loop, AL. For example, in an embodiment where AL=7, if enough audio is available, all possible combinations of M, N, and τ could be generated, for example, [M=6, N=0], [M=5, N=1], [M=4, N=2] . . . , [M=0, N=6] and

$$τ ∈ \{ \frac{{c}_{e} - {c}_{b}}{L} l , l = 0 , … , L - 1 \} ,$$

where L is 128.

As shown in block 708 of FIG. 7, the apparatus 100 may include means, such as the processor 102, memory 104, or the like, for determining the correlation between the audio from the beginning (AB) and the audio from the end (AE) of the looped audio of each combination. For example, the audio from the beginning and end of the looped audio for each combination is compared. The audio at the beginning, called AB, may be defined as the time period:

from: c_{b}−M(cₑ−c_{b})+τ to: c_{b}−M(cₑ−c_{b})+τ+o,

and the audio at the end, called AE, may be defined as the time period:

from: N(cₑ−c_{b})+τ to: N(cₑ−c_{b})+τ+o.

The apparatus may then determine the correlation between the AB and the AE for each combination of M, N and τ.

As shown in block 710 of FIG. 7, the apparatus 100 may include means, such as the processor 102, memory 104, or the like, for selecting the combination of combination of M, N and τ that produces the best correlation between AB and AE to use in creating the audio loop for the audio enhanced cinemagraph.

As shown in block 712 of FIG. 7, the apparatus 100 may include means, such as the processor 102, memory 104, or the like, for aligning the repeating audio loops for playback in the audio enabled cinemagraph. For example, in some embodiments, the repeating audio loops may be aligned such that the last o seconds (audio overlap length) of the audio overlaps with the first o seconds of the audio in the next repeat of the audio loop. In some embodiments, the last o seconds of the audio loop may be faded out and the first o seconds of the audio loop may be faded in, such as by using linear of other types of fade ins and fade outs.

Operation may then return to block 220 of FIG. 2 where the audio loop and video loop may be combined to generate an audio enabled cinemagraph, as illustrated in FIG. 5.

In another embodiment, instead of using correlation to find the best points for creating the audio loop as described above, the apparatus may choose to use the quietest places in the audio for looping. During the quiet parts of the audio, the overlap is very inaudible. Further, having important speech in the audio is less likely during the quiet parts of the audio and, as such, the audio overlap is less likely to happen in the middle of a word. If there is enough audio available, all possible combinations of M and N could be generated and the audio from the beginning (AB) and the audio from the end (AE) of the looped audio of each combination is compared. The combination of M and N that produces the quietest AB and AE may be used for creating the audio loop for the audio enabled cinemagraph. If there are several almost as good choices of combinations of M and N, the combination where both AB and AE are quiet and AB and AE are strongly correlated may be used.

FIG. 8 illustrates a flowchart of operations, which may be performed by an apparatus, such as apparatus 100, for generating an audio loop segment in accordance with an example embodiment as part of the operations described above with regard to FIG. 2. The operations illustrated by the flowchart of FIG. 8 may occur within block 218 of FIG. 2. Operations may begin by continuing from block 218 of FIG. 2.

As shown in block 802 of FIG. 8, the apparatus 100 may include means, such as the processor 102, memory 104, or the like, for determining the length of the audio overlap, o, needed for smooth audio looping. For example, the overlap may be a predefined value such as 0.25 seconds in some embodiments.

The apparatus 100 may include means, such as the processor 102, memory 104, or the like, for determining the amount of audio that is available before and after the looped video clip. See block 804 of FIG. 8. In an example embodiment, the apparatus may determine the number of segments of audio equal to the length of the video loop (cₑ−c_{b}) that are available before and after the video loop. For example, the apparatus may determine the maximum number of segments M, before the video loop, and N, after audio loop, (both are non-negative integers) so that:

cₑ+N(cₑ−c_{b})+o≦aₑ and a_{b}≦c_{b}−M(cₑ−c_{b}).

As shown in block 806 of FIG. 6, the apparatus 100 may include means, such as the processor 102, memory 104, or the like, for generating all possible combinations of M and N that generate the desired length audio loop, AL. For example, in an embodiment where AL=7, if enough audio is available, all possible combinations of M and N could be generated, for example, [M=6, N=0], [M=5, N=1], [M=4, N=2] . . . , [M=0, N=6].

As shown in block 808 of FIG. 8, the apparatus 100 may include means, such as the processor 102, memory 104, or the like, for determining the correlation between the audio from the beginning (AB) and the audio from the end (AE) of the looped audio of each combination. For example, the audio from the beginning and end of the looped audio for each combination is compared. The audio at the beginning, called AB, may be defined as the time period:

from: c_{b}−M(cₑ−c_{b}) to: c_{b}−M(cₑ−c_{b})+o,

and the audio at the end, called AE, may be defined as the time period:

from: N(cₑ−c_{b}) to: N(cₑ−c_{b})+o.

The apparatus may then compare the AB and the AE for each combination of M and N to determine the quietness of each combination.

As shown in block 810 of FIG. 8, the apparatus 100 may include means, such as the processor 102, memory 104, or the like, for selecting the combination of M and N that produces the quietest AB and AE to use in creating the audio loop for the audio enhanced cinemagraph. If there are several almost as good choices of combinations of M and N, the combination where both AB and AE are quiet and AB and AE are strongly correlated may be chosen.

As shown in block 812 of FIG. 8, the apparatus 100 may include means, such as the processor 102, memory 104, or the like, for aligning the repeating audio loops for playback in the audio enabled cinemagraph. For example, in some embodiments, the repeating audio loops may be aligned such that the last o seconds (audio overlap length) of the audio overlaps with the first o seconds of the audio in the next repeat of the audio loop. In some embodiments, the last o seconds of the audio loop may be faded out and the first o seconds of the audio loop may be faded in, such as by using linear of other types of fade ins and fade outs.

Operation may then return to block 220 of FIG. 2 where the audio loop and video loop may be combined to generate an audio enabled cinemagraph, as illustrated in FIG. 5.

In another embodiment, instead of detecting how quiet the signal is, a voice activity detector may be used. The combination of M and N that produces the smallest likelihood for speech during AB and AE may be chosen for creating the audio loop. In an example embodiment, to avoid interrupting speech during looping of the audio, it may be possible to try to record the audio for the cinemagraph from a direction that has as little speech as possible. For example, if the apparatus has directional microphones, audio for the cinemagraph may be chosen from the microphone signal that has lowest probability for speech.

In another embodiment, an apparatus may provide a user interface to receive user input for performing selection of the audio loop, such as illustrated in FIG. 10. For example, in an embodiment, an apparatus may cause a timeline to be displayed on a user interface which allows for receiving a user selection of the audio portion to be used in an audio enabled cinemagraph, In an example embodiment, the timeline may further provide a grid to force a user selection to be from only integer multiples of the video loop length for the beginning and end points of the audio loop.

FIG. 9 illustrates a flowchart of operations, which may be performed by an apparatus, such as apparatus 100, for generating an audio loop segment in accordance with an example embodiment as part of the operations described above with regard to FIG. 2. The operations illustrated by the flowchart of FIG. 9 may occur within block 218 of FIG. 2. Operations may begin by continuing from block 218 of FIG. 2.

As shown in block 902 of FIG. 9, the apparatus 100 may include means, such as the processor 102, memory 104, or the like, for determining the length of the audio overlap, o, needed for smooth audio looping. For example, the overlap may be a predefined value such as 0.25 seconds in some embodiments.

The apparatus 100 may include means, such as the processor 102, memory 104, user interface 106, or the like, for causing the display of timelines for the recorded video and the recorded audio, such as video timeline 1006 and audio timeline 1008 of FIG. 10. See block 904 of FIG. 9. In an example embodiment, the apparatus may determine the number of segments of audio equal to the length of the video loop that are available before and after the video loop, as described above, for use in displaying the audio timeline as integer multiples of the video loop.

As shown in block 906 of FIG. 9, the apparatus 100 may include means, such as the processor 102, memory 104, user interface 106, or the like, for causing an indication of the portion of the recorded video selected as the video loop to be displayed as part of the timelines, such as video loop 1010 of FIG. 10. In some example embodiments, the apparatus may include means, such as the processor 102, memory 104, user interface 106, or the like, to cause playback of the recorded video and audio upon receiving inputs, such as through play button 1018 and stop button 1016 of FIG. 10. In some example embodiments, since the recorded audio starts before and ends after the recorded video, the apparatus may cause the first or last frames of the recorded video to be displayed when audio before or after the boundaries of the recorded video is being played back.

As shown in block 908 of FIG. 9, the apparatus 100 may include means, such as the processor 102, memory 104, user interface 106, or the like, for receiving an indication of the position of a start marker for the desired audio segment, such as start arrow 1012 of FIG. 10. As shown in block 910 of FIG. 9, the apparatus 100 may include means, such as the processor 102, memory 104, user interface 106, or the like, for receiving an indication of the position of a stop marker for the desired audio segment, such as stop arrow 1014 of FIG. 10. In some example embodiments, the apparatus may limit the position selection of the start and stop markers to an audio timeline grid indicating the integer multiples of the length of the recorded video, such as the boundaries of the boxes on the audio timeline 1008 of FIG. 10.

As shown in block 912 of FIG. 9, the apparatus 100 may include means, such as the processor 102, memory 104, user interface 106, or the like, for generating the audio loop from the interval of the recorded audio between the start and stop markers.

As shown in block 914 of FIG. 9, the apparatus 100 may include means, such as the processor 102, memory 104, or the like, for aligning the repeating audio loops for playback in the audio enabled cinemagraph. For example, in some embodiments, the repeating audio loops may be aligned such that the last o seconds (audio overlap length) of the audio overlaps with the first o seconds of the audio in the next repeat of the audio loop. In some embodiments, the last o seconds of the audio loop may be faded out and the first o seconds of the audio loop may be faded in, such as by using linear of other types of fade ins and fade outs.

Operation may then return to block 220 of FIG. 2 where the audio loop and video loop may be combined to generate an audio enabled cinemagraph, as illustrated in FIG. 5.

In some embodiments, only some of the operations described in relation to FIG. 9 may be performed by an apparatus. For example, in some embodiments, the apparatus may provide for the display of the audio and video timelines and provide for an indication of a start time and a stop time for an audio segment to be selected by a user for use in generating an animated image. In some embodiments, the apparatus may provide for the display of the audio timeline and for a user selection of a start time and a stop time for an audio segment to be used in generating an animated image. Further, various other embodiments may be provided which perform some but not all of the operations described with regard to FIG. 9 above.

FIG. 10 illustrates an exemplary apparatus and user interface for generating an audio loop, such as by operations described with regard to FIG. 9, in accordance with an example embodiment of the present invention.

As shown in FIG. 10, the apparatus 100 may be embodied as device 1000 with user interface 1002 for displaying output to a user and receiving input from a user, such as a touchscreen or the like, for example. The user interface 1002 may include a display 1004 for displaying recorded video. The user interface 1002 may further include portions for display of controls and indications such as controls/indications 1006-1018, which may allow for display to a user as well as receiving input from a user. The device 1000 may further include recording interfaces or user interfaces for capturing images, video, and/or audio and providing audio output (not shown). The user interface 1002 may provide for display and/or selection of recorded video timeline 10006, recorded audio timeline 1008, video loop indication 1010, audio loop start marker 1012, audio loop stop marker 1014, playback start button 1016, and playback stop button 1018, for use in operations as described above with regard to FIG. 9.

In some example embodiments, when an audio enhanced cinemagraph is viewed, the audio playback may be started from a part of the looped audio where the audio and the video are in sync. In some example embodiments, the desired audio loop length (AL) may be limited to a fixed value, such as in seconds for example, instead of being dependent on the video loop length. In some example embodiments, the recorded audio may be trimmed to remove the end and/or beginning if there is device handling noise, for example. The noise can be detected easily because it makes the audio clip. In some example embodiments, the audio may be repeated only a predefined number of times and then stopped.

In some example embodiments, when generating automated cinemagraphs, the looped video may be trimmed in a rather straightforward manner from the recorded video. In some embodiments, generating the looped video may be performed such that the beginning of the looped video is taken to be the time at which the first frame of the looped video is taken from the recorded video and the end of the looped video is taken to be the beginning of the looped video plus the length of the looped video, i.e. begininng+number_of_taken_frames*framelength.

As described above, FIGS. 2, 4, and 6 through 9 illustrate flowcharts of an apparatus, method, and computer program product according to example embodiments of the invention. It will be understood that each block of the flowchart, and combinations of blocks in the flowchart, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory 104 of an apparatus employing an embodiment of the present invention and executed by a processor 102 of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowchart support combinations of means for performing the specified functions and combinations of operations for performing the specified functions for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included, such as shown by the blocks with dashed outlines. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
receiving at least two image frames and audio, wherein the duration of the audio is longer than the duration of the at least two image frames;
receiving a selection of a segment of the at least two image frames;
defining an output image by looping the selected segment of the at least two frames;
defining an output audio from the received audio based at least on a start time and a stop time of the selected segment; and
producing an animated image by at least combining the output image and the output audio.

2. A method according to claim 1, wherein the at least two image frames comprise video or multiple image captures and wherein receiving the at least two image frames comprises at least one of: recording video, capturing multiple images, and receiving previously stored image frames.

3. A method according to claim 1, wherein receiving the audio comprises at least one of: recording at least one audio signal at the same time as recording of the at least two image frames, recording at least one audio signal separately from recording of the at least two image frames, and receiving previously stored audio and wherein the duration of the received audio is at least as long as the duration of the received at least two image frames.

4. A method according to claim 1, wherein the selection of the segment of the at least two image frames comprises one of: automatically selecting a whole image comprising the at least two frames, receiving a selection of a whole image comprising the at least two frames, or receiving a selection of at least one region of a whole image comprising the at least two frames for generating a dynamic region and a selection of a region of the whole image for generating a substantially static region.

5. A method according to claim 1, wherein the duration of the output audio is an integer multiple of the duration of the output image.

6. A method according to claim 1, wherein generating the animated image further comprises overlapping multiple instances of the output audio by a specified duration.

7. A method according to claim 1, wherein generating the animated image further comprises the output image and the output audio being synchronized at regular intervals.

8. A method according to claim 1, wherein generating the output audio further comprises:
determining an amount of audio overlap to be used in generating the animated image;
determining an amount of audio segments in the received audio before and after the output image, wherein an audio segment is the same length as the output image;
determining a desired length for the output audio; and
selecting an integer multiple of audio segments before and after the output image to generate the desired length output audio.

9. A method according to claim 1, wherein generating the output audio further comprises:
determining an amount of audio overlap to be used in generating the animated image;
determining an amount of audio segments in the received audio before and after the output image, wherein an audio segment is the same length as the output image;
determining a desired length for the output audio;
generating a set of potential audio outputs, wherein the potential audio outputs are different combinations of the audio segments before and after the output image which provide the desired length output audio;
for each potential audio output, determining at least one of:
a correlation between an overlap segment at the beginning of the potential audio output and an overlap segment at the end to of the potential audio output, wherein the overlap segments are equal to the amount of audio overlap; or
a quietness of an overlap segment at the beginning of the potential audio output and an overlap segment at the end to of the potential audio output, wherein the overlap segments are equal to the amount of audio overlap; and
selecting the potential audio output with the best correlation or that produces a quietest overlap as the output audio for use in generating the animated image.

10. A method according to claim 1, wherein generating the output audio further comprises:
determining an amount of audio overlap to be used in generating the animated image;
determining an amount of audio segments in the received audio before and after the output image, wherein an audio segment is the same length as the output video loop;
causing display of a received image frame timeline and a received audio timeline;
causing display of an indication of the output image on the timelines;
receiving a selection of a start position and a stop position on the received audio timeline; and
generating the output audio using a segment of received audio between the start position and the stop position.

11. An apparatus comprising at least one processor and at least one memory including computer program instructions, the at least one memory and the computer program instructions configured to, with the at least one processor, cause the apparatus at least to:
receive at least two image frames and audio, wherein the duration of the audio is longer than the duration of the at least two image frames;
receive a selection of a segment of the at least two image frames;
define an output image by looping the selected segment of the at least two frames;
define an output audio from the received audio based at least on a start time and a stop time of the selected segment; and
produce an animated image by at least combining the output image and the output audio.

12. An apparatus according to claim 12, wherein the at least two image frames comprise video or multiple image captures and wherein causing the apparatus to receive the at least two image frames comprises the at least one memory and the computer program instructions further configured to, with the at least one processor, cause the apparatus to perform at least one of: recording video, capturing multiple images, and receiving previously stored image frames.

13. An apparatus according to claim 12, wherein causing the apparatus to receive the audio comprises the at least one memory and the computer program instructions further configured to, with the at least one processor, cause the apparatus to perform at least one of: recording at least one audio signal at the same time as recording of the at least two image frames, recording at least one audio signal separately from recording of the at least two image frames, and receiving previously stored audio and wherein the duration of the received audio is at least as long as the duration of the received at least two image frames.

14. An apparatus according to claim 12, wherein the selection of the segment of the at least two image frames comprises one of automatically selecting a whole image comprising the at least two image frames, receiving a selection of a whole image comprising the at least two image frames, or receiving a selection of at least one region of a whole image comprising the at least two image frames for generating a dynamic region and a selection of a region of the whole image for generating a substantially static region.

15. An apparatus according to claim 12, wherein generating the animated image further comprises overlapping multiple instances of the output audio by a specified duration.

16. An apparatus according to claim 12, wherein generating the animated image further comprises the output image and the output audio being synchronized at regular intervals.

17. An apparatus according to claim 12, wherein causing the apparatus to generate the output audio further comprises the at least one memory and the computer program instructions further configured to, with the at least one processor, cause the apparatus at least to:
determine an amount of audio overlap to be used in generating the animated image;
determine an amount of audio segments in the received audio before and after the output image, wherein an audio segment is the same length as the output image;
determine a desired length for the output audio; and
select an integer multiple of audio segments before and after the output image to generate the desired length output audio.

18. An apparatus according to claim 12, wherein causing the apparatus to generate the output audio further comprises the at least one memory and the computer program instructions further configured to, with the at least one processor, cause the apparatus at least to:
determine an amount of audio overlap to be used in generating the animated image;
determine an amount of audio segments in the received audio before and after the output image, wherein an audio segment is the same length as the output image;
determine a desired length for the output audio;
generate a set of potential audio outputs, wherein the potential audio outputs are different combinations of the audio segments before and after the output image which provide the desired length output audio;
for each potential audio outputs, determine at least one of:
a correlation between an overlap segment at the beginning of the potential audio output and an overlap segment at the end to of the potential audio output, wherein the overlap segments are equal to the amount of audio overlap; or
a quietness of an overlap segment at the beginning of the potential audio output and an overlap segment at the end to of the potential audio output, wherein the overlap segments are equal to the amount of audio overlap; and
select the potential audio output with the best correlation or that produces the quietest overlap as the output audio for use in generating the animated image.

19. An apparatus according to claim 12, wherein causing the apparatus to generate the output audio further comprises the at least one memory and the computer program instructions further configured to, with the at least one processor, cause the apparatus at least to:
determine an amount of audio overlap to be used in generating the animated image;
determine an amount of audio segments in the received audio before and after the output image, wherein an audio segment is the same length as the output image;
cause display of a received image frames timeline and a received audio timeline;
cause display of an indication of the output image on the timelines;
receive a selection of a start position and a stop position on the received audio timeline; and
generate the output audio using the segment of received audio between the start position and the stop position.

20. An apparatus according to claim 12, further comprising a user interface, the user interface configured to:
provide for display of the received at least two image frames;
provide for selection of the segment of at least two image frames or selection of regions of an image for generating a dynamic region and a substantially static region;
provide for display of a received image frames timeline and a received audio timeline; and
provide for selection of a start position and a stop position on the received audio timeline.
